(19) United States
(12) Patent Application Publication
(10) Pub. No.: US 2019/0136820 A1
(43) Pub. Date: May 9, 2019

(54) METHODS AND APPARATUS FOR AN IGNITION SYSTEM

(71) Applicant: SEMICONDUCTOR COMPONENTS INDUSTRIES, LLC, Phoenix, AZ (US)

(72) Inventor: Mikio YAMAGISHI, Fukaya-shi (JP)

(73) Assignee: SEMICONDUCTOR COMPONENTS INDUSTRIES, LLC, Phoenix, AZ (US)

(21) Appl. No.: 15/805,252

(22) Filed: Nov. 7, 2017

(51) Int. Cl. F02P 3/045; F02P 9/00; F02P 3/055

(52) U.S. Cl. CPC F02P 3/0453; F02P 3/055; F02P 9/002

(57) ABSTRACT

Various embodiments of the present technology comprise a method and apparatus for an ignition system. In various embodiments, the ignition system activates a soft shutdown of an ignition coil in the event of an over dwell condition. The apparatus comprises first and second voltage-to-current converters and utilizes a difference of the converter outputs to control the current through the ignition coil. During the soft shutdown, the current decreases non-linearly during a first period and decreases linearly during an immediately following second period.

### BACKGROUND OF THE TECHNOLOGY

An ignition coil typically used in ignition systems may be electrically controlled. Specifically, an electronic control unit (ECU) generally controls the dwell time of the ignition coil. The dwell time is the period of time that the coil is turned ON and is usually predetermined based on the system application. In some cases, however, malfunctions of the ECU may result in the ignition coil being turned on longer than it should (this condition may be referred to as “over dwell”), which may cause damage (e.g., melting) to the ignition coil. In such a case, many conventional systems activate a “soft shutdown” operation to slowly reduce the current through the ignition coil if the ignition coil operation time goes into over dwell. Conventional soft shutdown methods, however, may induce an unintentional spark at the spark plug during the soft shutdown period due to an inductive kickback that occurs at the beginning of the soft shutdown period.

### SUMMARY OF THE INVENTION

Various embodiments of the present technology comprise a method and apparatus for an ignition system. In various embodiments, the ignition system activates a soft shutdown of an ignition coil in the event of an over dwell condition. The apparatus comprises first and second voltage-to-current converters and utilizes a difference of the converter outputs to control the current through the ignition coil. During the soft shutdown, the current decreases non-linearly during a first period and decreases linearly during an immediately following second period.

### BRIEF DESCRIPTION OF THE DRAWING FIGURES

A more complete understanding of the present technology may be derived by referring to the detailed description when considered in connection with the following illustrative figures. In the following figures, like reference numbers refer to similar elements and steps throughout the figures.

FIG. 1 is a block diagram of an ignition system in accordance with an exemplary embodiment of the present technology;

FIG. 2 is a circuit diagram of an igniter in accordance with an exemplary embodiment of the present technology;

FIG. 3 is a graph illustrating I-V characteristics of voltage-to-current converters in accordance with an exemplary embodiment of the present technology;

FIG. 4A is a graph illustrating an electronic control unit signal over time in accordance with an exemplary embodiment of the present technology;

FIG. 4B is a graph illustrating a coil current over time in accordance with an exemplary embodiment of the present technology;

FIG. 4C is a graph illustrating a secondary voltage of an ignition coil over time in accordance with an exemplary embodiment of the present technology;

FIG. 4D is a graph illustrating a ramp generator output over time in accordance with an exemplary embodiment of the present technology;

FIG. 4E is a graph illustrating voltage-to-current converter outputs in accordance with an exemplary embodiment of the present technology;

FIG. 4F is a graph illustrating the voltage at a reference node in accordance with an exemplary embodiment of the present technology; and

FIG. 5 is a graph illustrating a soft shutdown period of an ignition system in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various power supplies, current supplies, current limiters, voltage-to-current converters, ignition coils, and the like, which may carry out a variety of functions. In addition, the present technology may be practiced in conjunction with any number of systems, such as automotive, marine, and aerospace, and the systems described are merely exemplary applications for the technology. Further, the present technology may employ any number of conventional techniques for providing a control signal, providing a current supply, limiting current flow, and the like.

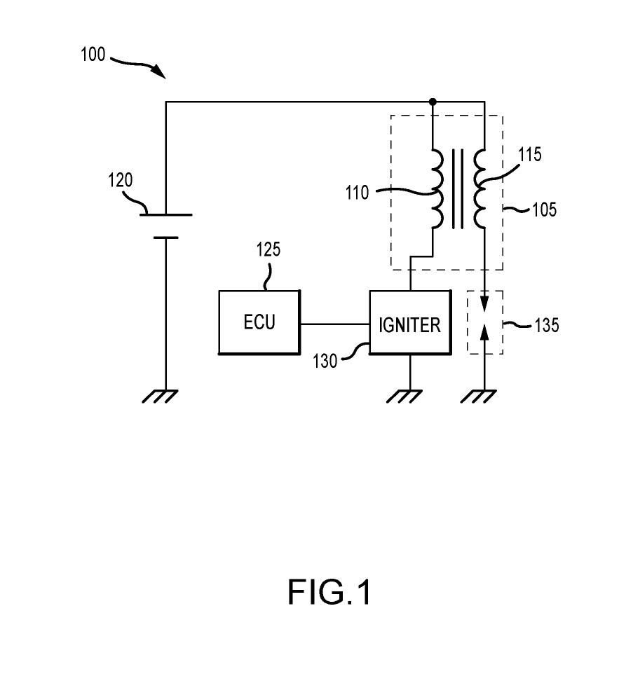

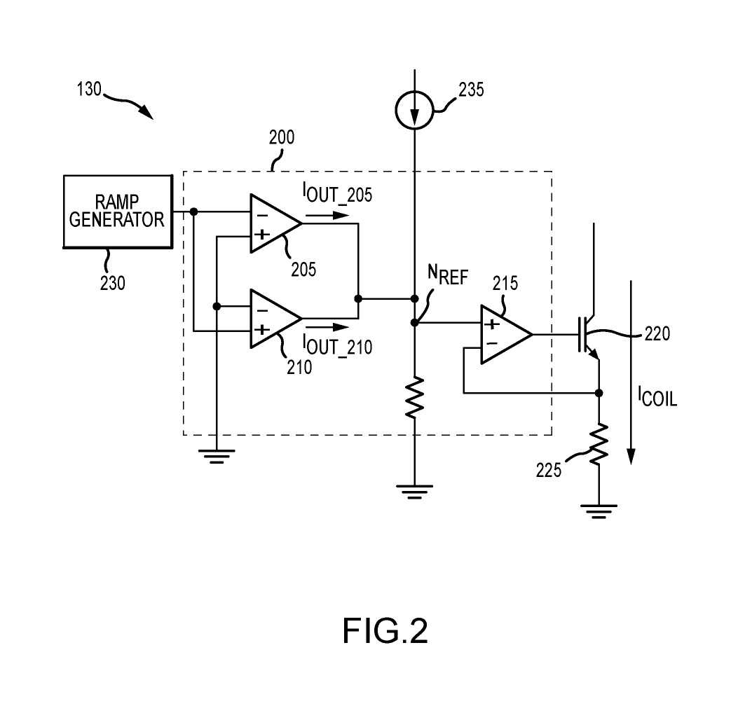

Methods and apparatus for an ignition system according to various aspects of the present technology may operate in conjunction with any suitable automotive system, such as an automobile with an internal combustion engine, and the like. Referring to FIGS. 1 and 2, an exemplary ignition system 100 may be incorporated into an automotive system powered by an internal combustion engine. For example, in various embodiments, the ignition system 100 may comprise an electronic control unit (ECU) 125, an igniter 130, an ignition coil 105, a power source 120, and a spark plug 135 that operate together to generate a very high voltage and create a spark that ignites the fuel-air mixture in the engine's combustion chambers.

The power source 120 acts as a power supply to the ignition system 100. For example, the power source 120 may generate a DC (direct current) voltage supply. The power source 120 may comprise any suitable device and/or system for generating power. For example, the power source 120 may comprise a 12-volt lead-acid battery commonly used in automotive applications. In an exemplary embodiment, the power source 120 may be coupled to the ignition coil 105. In various embodiments, the power source 120 may also be coupled to other components, such as the ECU 125, to facilitate operation.

The ECU 125 may control various operations of one or more components in the ignition system 100. For example, the ECU 125 may be configured to transmit various control signals representing an ON/OFF mode, a particular operating state, and the like. In an exemplary embodiment, the ECU 125 may be coupled to the igniter 130 and configured to transmit an ECU signal to operate the igniter 130. For example, the ECU signal may represent the ON/OFF mode of the igniter 130, which in turn controls operation of the ignition coil 105. In some cases, the ECU 125 may malfunction, resulting in unintended operation of the igniter 130 and ignition coil 105.

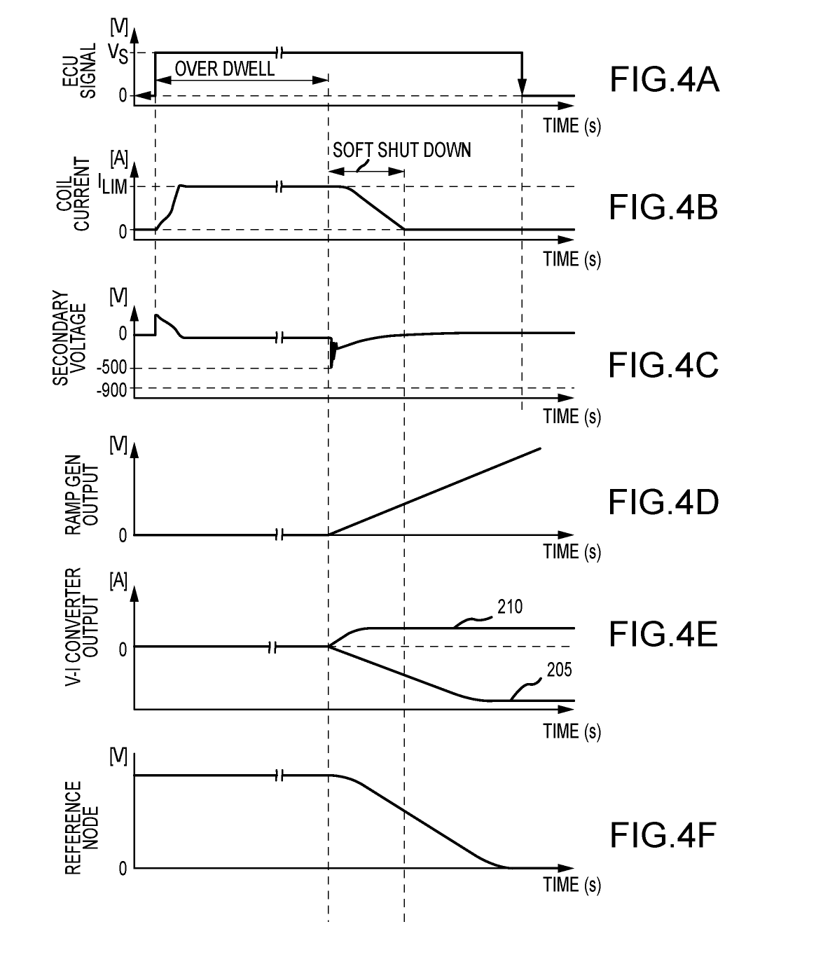

In general, the ECU 125 may be programmed with a predetermined dwell time, which is the preferred amount of time that the ignition coil 130 should be in the ON mode to achieve normal operation. The dwell time may be selected according to the particular application, the rated size of the power source 120, and/or transformation capabilities of the ignition coil 105. In some cases, the dwell time be based on a coil current limit I_{LIM} (FIG. 4B), such that the ECU 125 turns off the igniter 130 after the current through the ignition coil 105 has reached the coil current limit I_{LIM}. In a case where the ECU 125 does not turn off the igniter 130 at the desired time, the igniter 130 and ignition coil 105 will continue to operate in the ON mode for a period of time referred to as “over dwell.”

The ignition coil 105 transforms the DC voltage of the power source 120 to a higher voltage needed to create an electric spark in the spark plug 135, which in turn ignites the fuel-air mixture fed to the engine. For example, the ignition coil 105 may be electrically coupled to a positive terminal of the power source 120 and the spark plug 135. The ignition system 100 may comprise any suitable coil, for example, an induction coil. In various embodiments, the ignition coil 105 may comprise a primary coil 110 with a primary voltage V_{C1} and a secondary coil 115 with a secondary voltage V_{C2}. In an exemplary embodiment, the primary coil 110 comprises a wire with relatively few turns and the secondary coil 115 comprises a wire thinner than that used in the primary coil 110 with many more turns. In general, the ignition coil 105 may be described according to a turn ratio (N=N2/N1), which is the number of turns of the secondary coil 115 (N2) to the number of turns of the primary coil 110 (N1). In general, the secondary voltage V_{C2} is equal to the primary voltage V_{C1} multiplied by the turn ratio. Accordingly, the secondary voltage V_{C2} is higher than the primary voltage V_{C1}. In an exemplary embodiment, the primary coil 110 may be coupled to the igniter 130 and the secondary coil 115 may be coupled to the spark plug 135.

According to various embodiments, the igniter 130 controls and/or measures (or detect or sense) a coil current I_{COIL} through ignition coil 105. In an exemplary embodiment, the igniter 130 may be coupled to the primary coil 110 and the coil current I_{COIL} may be a current through the primary coil 110. The igniter 130 may comprise various circuit devices and/or systems for current sensing, signal amplification, controlling a reference voltage, converting a voltage to a current, controlling and/or limiting a current, and the like. For example, the igniter 130 may comprise a ramp generator 230, a first voltage-to-current converter 205, a second voltage-to-current converter 210, a current limiter circuit 215, and a switch element 220.

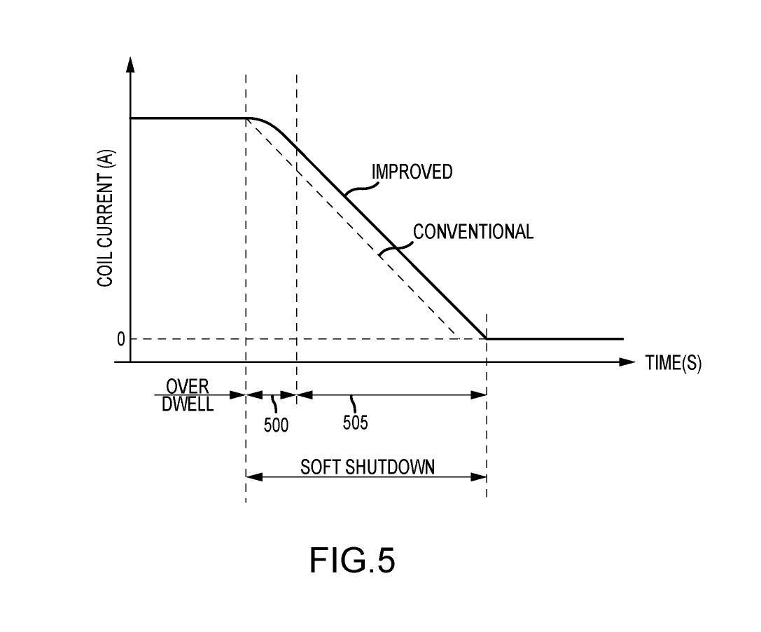

Referring to FIGS. 1, 2 and 5, the igniter 130 is configured to control the coil current I_{COIL} and to provide a soft shutdown operation of the ignition coil 105. In an exemplary embodiment, the igniter 130 may comprise a protection circuit 200 that operates in conjunction with a switch element 220 to gradually reduce a current through the primary coil 110 (i.e., a coil current I_{COIL}) until the ignition coil 105 is fully shutdown and no longer providing a voltage to the spark plug 135. In the present case, and referring to FIG. 5, the igniter 130 reduces the coil current I_{COIL} in a non-linear fashion during a first period 500 of the soft shutdown. The igniter 130 further reduces the coil current I_{COIL} in a linear fashion during a second period 505 until the coil current I_{COIL} reaches zero. In an exemplary embodiment, the linearly decreasing period (i.e., the second period 505) immediately follows the non-linearly decreasing period (i.e., the first period 500). The total time for the soft shutdown operation may be referred to as a soft shutdown period T_{SSD}.

The particular length of time for the soft shutdown T_{SSD} may depend on an inductance L of the primary coil 110, the turn ratio N of the ignition coil 105, and the secondary voltage V_{C2}, and the primary voltage V_{C1}. In general, the primary voltage V_{C1} is defined as: V_{C1}=L×di/dt; and the secondary voltage is defined as: V_{C2}=N×V_{C1}=N×L×di/dt. Further, the soft shutdown period T_{SSD} may be defined as: T_{SSD}=N×L×I_{COIL}/V_{C2}. In the case where the coil current I_{COIL} reaches the coil current limit I_{LIM}, the soft shutdown period T_{SSD} may be defined as: T_{SSD}=N×L×I_{LIM}/V_{C2}. In an exemplary embodiment, the soft shutdown period TSSD may range from approximately 5 milliseconds (ms) to 30 ms, the first period 500 may range from approximately 0.5 ms to 3 ms, and the second period 505 may range from approximately 5 ms to 30 ms. In particular, it may be desired that the length of time of the first period 500 is less than approximately 10% of the soft shutdown period T_{SSD}. In any case, it may be desired that the soft shutdown period T_{SSD} is as short as possible to prevent damage to the ignition coil 105 while reducing the coil current I_{COIL} in the manner described above in order to prevent an unintentional spark.

The ramp generator 230 may be configured to generate a first reference voltage, such as a ramp voltage V_{RAMP}. In an exemplary embodiment, the ramp generator 230 may be configured to transmit the ramp voltage V_{RAMP} to the protection circuit 200. For example, the ramp generator 230 may be coupled to and configured to transmit the ramp voltage V_{RAMP} to the first and second voltage-to-current converters 205, 210. The ramp generator 230 may comprise any suitable ramp generation circuit and/or system. The ramp generator 230 may also be coupled to the ECU 125. In various embodiments, the ramp generator 230 may be responsive to a control signal from the ECU 125. The control signal may be configured to active/deactivate the ramp generator 230.

The protection circuit 200 may be configured to convert a voltage to a current, provide a difference current of multiple currents, amplify a signal, and/or facilitate limiting the coil current I_{COIL}. The protection circuit 200 may operate in conjunction with the ramp generator 230 and the switch element 220 to generate a desired coil current I_{COIL} during the soft shutdown. The particular magnitude of the coil current I_{COIL} during the soft shutdown may be selected according to the rated size of the power source 120, the particular application, and/or transformation capabilities of the ignition coil 105.

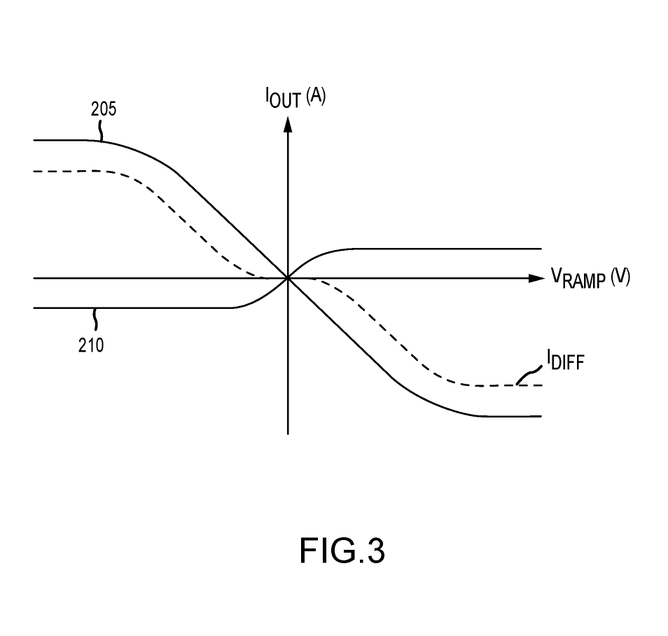

In an exemplary embodiment, the protection circuit 200 may comprise the first voltage-to-current converter 205 (i.e., a voltage controlled current source) to control a first output current I_{OUT}_{_}₂₀₅ according to an input voltage and the second-to-voltage converter 210 to control a second output current I_{OUT}_{_}₂₁₀ according to an input voltage. The first and second voltage-to-current converters 205, 210 may comprise any suitable circuit and/or system for controlling a current according to an input voltage, such as an operational transconductance amplifier. In various embodiments, the first and second voltage-to-current converters 205, 210 may be coupled to the ramp generator 230 and configured to receive the ramp voltage V_{RAMP}. For example, in an exemplary embodiment, the first voltage-to-current converter 205 comprises an inverting input terminal (−) and a non-inverting input terminal (+), wherein the inverting input terminal is coupled to the ramp generator 230 to receive the ramp voltage V_{RAMP} and the non-inverting input terminal is coupled to a second reference voltage, such as a ground reference. Further, the second voltage-to-current converter 210 comprises an inverting input terminal (−) and a non-inverting input terminal (+), wherein the non-inverting input terminal is coupled to the ramp generator 230 to receive the ramp voltage V_{RAMP} and the inverting input terminal is coupled to the second reference voltage and the non-inverting input terminal of the first voltage-to-current converter 205. Accordingly, the first and second voltage-to-current converts 205, 210 have I-V characteristics (I-V curves) that behave differently. For example, and referring to FIG. 3, as the ramp voltage V_{RAMP} increases, the first output current T_{OUT}_{_}₂₀₅ of the first voltage-to-current converter 205 decreases, while the second output current I_{OUT}_{_}₂₁₀ of the second voltage-to-current converter 210 increases. Similarly, as the ramp voltage V_{RAMP} decreases, the second output current I_{OUT}_{_}₂₁₀ of the second voltage-to-current converter 210 decreases, while the first output current T_{OUT}_{_}₂₀₅ of the first voltage-to-current converter 205 increases. The particular value of the first and second output currents I_{OUT}_{_}₂₀₅, T_{OUT}_{_}₂₁₀ may be based on the particular application, rated voltage of the power source 120, the ramp voltage V_{RAMP} , and other relevant parameters. For example, with a ramp voltage V_{RAMP} ranging from 1-3V, the first output current I_{OUT}_{_}₂₀₅ may range from approximately +100 μA to −100 μA, and the second output current I_{OUT}_{_}₂₁₀ may range from approximately +(2-4) μA to −(2-4) μA.

In an exemplary embodiment, the protection circuit 200 is configured to produce a difference signal (e.g., a difference current I_{DIFF}) to control a third reference voltage at a reference node N_{REF}. For example, an output terminal of the first voltage-to-current converter 205 is electrically coupled to an output terminal of the second voltage-to-current converter 210 at the reference node N_{REF}, such that the first and second current outputs T_{OUT}_{_}₂₀₅, T_{OUT}_{_}₂₁₀ are combined to produce the difference current I_{DIFF}, which directly affects the third reference voltage at the reference node N_{REF}. Accordingly, an I-V characteristic of both the first and second voltage-to-current converters 205, 210 together (i.e., the difference current I_{DIFF} as the ramp voltage V_{RAMP} increases) will have a curve characteristic that falls between the individual I-V curves.

The current limiter circuit 215 is configured to control operation of the switch element 220. For example, an output of the current limiter circuit 215 may be coupled to an input of the switch element 220, wherein the switch element 220 is responsive to the current limiter circuit 215 output. The current limiter circuit 215 may also be configured to amplify a signal at its input terminal. For example, in an exemplary embodiment, the current limiter circuit 215 comprises a non-inverting input terminal and an inverting input terminal, wherein the non-inverting input terminal may be coupled to the reference node N_{REF} and responsive to the third reference voltage. The current limiter circuit 215 may generate an output voltage at an output terminal according to the third reference voltage at the reference node N_{REF}. In an exemplary embodiment, the output terminal is coupled to the switch element 220, wherein the switch element 220 is responsive to the output voltage of the current limiter circuit 215. The current limiter circuit 215 may comprise any suitable circuit for amplifying and/or attenuating an input signal. For example, the current limiter circuit 215 may comprise an operational amplifier or any other suitable amplifier with variable gain.

In an exemplary embodiment, the current limiter circuit 215 may be coupled to a feedback loop that senses/detects the coil current I_{COIL}. The feedback loop may operate in conjunction with a sense resistor 225 to detect the magnitude of the coil current I_{COIL}. For example, the feedback loop may be connected at a point between a terminal of the switch element 220 and the sense resistor 225, and to the inverting input terminal of the current limiter circuit 215. The current limiter circuit 215 may be responsive to the magnitude of the coil current I_{COIL}. For example, the current limiter circuit 215 may utilize this information to adjust its output signal (e.g., increase or decrease the magnitude of the output voltage) according to the desired coil current limit I_{LIM} (FIG. 4B).

The switch element 220 is configured to control operation of the ignition coil 105. For example, in an exemplary embodiment, the switch element 220 is coupled to the primary coil 110 and controls the coil current I_{COIL}. The switch element 220 may comprise any circuit and/or system suitable capable of controlling a current flow.

In an exemplary embodiment, the switch element 220 comprises an insulated-gate bipolar transistor (IGBT) having a gate terminal, an emitter terminal, and a collector terminal. In the present embodiment, the collector terminal is coupled to the primary coil 110, the emitter terminal is coupled to the sense resistor 225, and the gate terminal is coupled to an output of the current limiter circuit 215. Accordingly, the switch element 220 is responsive to the current limiter circuit 215 and as the voltage to the gate terminal (i.e., the gate voltage) increases, the coil current I_{COIL}also increases.

According to various embodiments, the igniter 130 may further comprise a current source 235 configured to provide a bias current to the protection circuit 200. For example, in an exemplary embodiment, the current source 235 is coupled to the reference node N_{REF} positioned between the outputs of the first and second voltage-to-current converters 205, 210 and the current limiter circuit 215. The bias current generated by the current source 235 may operate in conjunction with the sense resistor 225 to achieve the desired coil current limit I_{LIM}. The current source 235 may comprise any suitable circuit and/or system configured to generate a predetermined current.

In operation, the protection circuit 200 activates a soft shutdown of the ignition coil 105 in a case of a malfunction, such as a malfunction of the ECU 125, which results in current flowing through the ignition coil 105 for an extended period of time. In an exemplary embodiment, the protection circuit 200 operates to decrease the coil current I_{COIL} in a particular manner to reduce the inductive kickback that may occur during the soft shutdown. Doing so prevents an unintentional spark of the spark plug 135. In general, the inductive kickback appears as a voltage spike, for example as illustrated in FIG. 4C, at the beginning of the soft shutdown.

In an exemplary embodiment, and referring to FIGS. 1, 2, 4D, and 4E, 4F, the coil current I_{COIL} is a function of the output signal (e.g., the output voltage) of the protection circuit 200. The ramp generator 230 generates the ramp voltage V_{RAMP} and transmits the ramp voltage V_{RAMP} to the protection circuit 200. For example, the ramp generator 230 transmits the ramp voltage V_{RAMP} to the first and second voltage-to-current converters 205, 210, wherein the first and second voltage-to-current converter 205, 210 output currents T_{OUT}_{_}₂₀₅, T_{OUT}_{_}₂₁₀ are controlled according to the ramp voltage V_{RAMP}. The protection circuit 200 effectively combines the current outputs I_{OUT}_{_}₂₀₅, T_{OUT}_{_}₂₁₀ to produce the difference current I_{DIFF}. Accordingly, as the ramp voltage V_{RAMP} increases, the difference current I_{DIFF} changes, thereby changing the third reference voltage at the reference node N_{REF}. In other words, the third reference voltage is proportional to the difference current I_{DIFF} and the bias current from the current source 235. The third reference voltage, in turn, controls the current limiter circuit 215. For example, the non-inverting input terminal of the current limiter circuit 215 is coupled to the reference node N_{REF} and responsive to the third reference voltage, so as the difference current I_{DIFF} decreases, the third reference voltage decreases, and the output voltage of the current limiter circuit 215 decreases.

The switch element 220 controls the current coil I_{COIL} and is responsive to the output signal of the protection circuit 200. For example, the switch element 220 may be coupled to the output terminal of the current limiter circuit 215 and responsive to the output voltage of the current limiter circuit 215. In one embodiment, wherein the switch element 220 comprises an IGBT, the IGBT operates according to a voltage applied to the gate terminal. Accordingly, as the gate voltage of the IGBT decreases, the coil current I_{COIL} also decreases, and vice versa.

In various embodiments and referring to FIGS. 4A-F and 5, the protection circuit 200 controls the coil current I_{COIL} such that the soft shutdown comprises a non-linear period 500 (i.e., a first period), where the coil current I_{COIL} decreases in a non-linear manner, and a linear period 505 (i.e., a second period), where the coil current I_{COIL} decreases in a linear manner. The non-linear decrease in the current coil I_{COIL} is due to the effect that the second voltage-to-current converter 210 has on the difference current I_{DIFF}. In conventional systems that use only one voltage-to-current converter, the coil current would decrease linearly for the entire soft shutdown period, for example as illustrated in FIG. 5. It is the sudden decrease in coil current I_{COIL} that leads to higher inductive kickback resulting in an unintentional spark.

In an exemplary embodiment, the non-linear period 500 occurs earlier in time than the linear period 505. The non-linear decrease in the coil current I_{COIL} reduces the inductive kickback of the ignition coil 105, thus limiting the secondary voltage and preventing an unintentional spark. In an exemplary embodiment, it may be desirable to limit the secondary voltage to 1000 volts or less, however, the particular voltage limit may be selected according to the turn ratio of the ignition coil 105, the rated voltage of the power source 120, and any other influencing variables. In any case, the secondary voltage limit may be selected to prevent an unintentional spark of the spark plug 135.

In the foregoing description, the technology has been described with reference to specific exemplary embodiments. The particular implementations shown and described are illustrative of the technology and its best mode and are not intended to otherwise limit the scope of the present technology in any way. Indeed, for the sake of brevity, conventional manufacturing, connection, preparation, and other functional aspects of the method and system may not be described in detail. Furthermore, the connecting lines shown in the various figures are intended to represent exemplary functional relationships and/or steps between the various elements. Many alternative or additional functional relationships or physical connections may be present in a practical system.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology, as expressed in the following claims.

1. An igniter capable of controlling an ignition coil, comprising:
a ramp generator configured to generate a ramp voltage; and
a protection circuit coupled to the ramp generator and comprising:
a first voltage-to-current converter coupled to an output terminal of the ramp generator; and
a second voltage-to-current converter coupled to the output terminal of the ramp generator;
wherein an output of each of the first and second voltage-to-current converters are coupled to each other at a reference node.

2. The igniter according to claim 1, wherein:
the first voltage-to-current converter is configured to control a first current that decreases a reference voltage at the reference node as the ramp voltage increases; and
the second voltage-to-current converter is configured to control a second current that increases the reference voltage at the reference node as the ramp voltage increases.

3. The igniter according to claim 2, wherein the protection circuit is configured to produce a difference signal of the first and second currents at the reference node.

4. The igniter according to claim 1, wherein:
the first voltage-to-current converter comprises an inverting input terminal coupled to the output terminal of the ramp generator; and
the second voltage-to-current converter comprises an inverting input terminal coupled to:
the non-inverting input terminal of the first voltage-to-current converter; and
a non-inverting input terminal coupled to the output terminal of the ramp generator.

5. The igniter according to claim 1, further comprising a switch element coupled to an output of the protection circuit.

6. The igniter according to claim 5, wherein the switch element comprises an insulated-gate bipolar transistor (IGBT), comprising:
a gate terminal coupled to the output of the protection circuit; and
a collector terminal coupled to the ignition coil; and
an emitter terminal coupled to a sense resistor.

7. The igniter according to claim 6, wherein the protection circuit is configured to limit a current through the ignition coil according to a voltage at the reference node to produce a soft shut down period, wherein the soft shut down period comprises:
a first period of non-linearly decreasing current; and
a second period, immediately following the first period, of linearly decreasing current.

8. The igniter according to claim 6, wherein the protection circuit further comprises a current limiter circuit configured to limit a gate voltage of the IGBT according to a current of the ignition coil.

9. A method for forming an ignition system having an ignition coil, comprising:
forming an igniter circuit adapted to couple to the ignition coil and capable of:
generating a ramp voltage;
generating a difference signal;
controlling a reference voltage with the difference signal; and
limiting a current through the ignition coil according to the reference voltage to produce a soft shut down period, wherein:
the soft shut down period comprises:
a first period of non-linearly decreasing current; and
a second period, immediately following the first period, of linearly decreasing current.

10. The method according to claim 9, wherein limiting the current through the ignition coil comprises reducing a gate voltage to an insulated-gate bipolar transistor (IGBT).

11. The method according to claim 9, further comprising limiting a secondary voltage of the ignition coil to a value less than 1000 volts.

12. The method according to claim 9, wherein generating the difference signal comprises:
generating a first current output according to the ramp voltage;
generating a second current output according to the ramp voltage; and
subtracting the second current from the first current.

13. The method according to claim 9, wherein:
the first current output decreases a reference voltage at a reference node as the ramp voltage increases; and
the second current output increase the reference voltage at the reference node as the ramp voltage increases.

14. An ignition system, comprising:
an ignition coil; and
an igniter coupled to the ignition coil and comprising:
a ramp generator configured to generate a ramp voltage;
a protection circuit, comprising:
a first voltage-to-current converter coupled to an output terminal of the ramp generator;
a second voltage-to-current converter coupled to the output terminal of the ramp generator; wherein an output of each of the first and second voltage-to-current converters are coupled to each other at a reference node; and
a current limiter circuit coupled to the reference node; and
a switch element coupled to:
an output terminal of the protection circuit; and
the ignition coil.

15. The ignition system according to claim 14, wherein:
the first voltage-to-current converter is configured to control a first current that decreases a reference voltage at the reference node as the ramp voltage increases; and
the second voltage-to-current converter is configured to control a second current that increases the reference voltage at the reference node as the ramp voltage increases.

16. The ignition system according to claim 14, wherein the switching element comprises an insulated-gate bipolar transistor (IGBT), comprising:
a gate terminal coupled to the output terminal of the current limiter circuit; and
a collector terminal coupled to the ignition coil.

17. The ignition system according to claim 16, wherein the protection circuit is configured to limit a secondary voltage of the ignition coil to a value less than 1000 volts.

18. The ignition system according to claim 14, wherein the protection circuit is configured to produce a difference signal of the first and second currents at the reference node.

19. The ignition system according to claim 14, wherein the switch element is responsive to a feedback loop configured to indicate a magnitude of current though the ignition coil.

20. The ignition system according to claim 14, wherein:
the first voltage-to-current converter comprises: an inverting input terminal coupled to the output terminal of the ramp generator; and
the second voltage-to-current converter comprises:
an inverting input terminal coupled to the non-inverting input terminal of the first voltage-to-current converter; and
a non-inverting input terminal coupled to the output terminal of the ramp generator.
